(19) United States
(12) Patent Application Publication
(10) Pub. No.: US 2018/0165661 A1
(43) Pub. Date: Jun. 14, 2018

(54) ELECTRONIC TIPPING, CONTRIBUTION, AND FEEDBACK SYSTEM AND METHOD

(71) Applicant: TipQuik, Inc., Simi Valley, CA (US)

(72) Inventors: Joel Macht, Simi Valley, CA (US); Andrew Macht, Northridge, CA (US); Richard Macht, Delray Beach, FL (US)

(21) Appl. No.: 14/711,660

(22) Filed: May 13, 2015

Related U.S. Application Data
(60) Provisional application No. 61/992,344, filed on May 13, 2014.

(51) Int. Cl. G06Q 20/10; G06Q 20/40

(52) U.S. Cl. CPC G06Q 20/10; G06Q 20/4014

(57) ABSTRACT

An electronic fund transfer system and method using a mobile application for convenience and privacy. The electronic fund transfer method comprises using a mobile computing device with an installed application to identify and transfer funds to a person or business with a limited exchange of personal information. A giver and receiver of a fund transfer each chooses his or her own level of identification information disclosure, allowing for anonymous fund transfers for givers and minimal disclosure for receivers.

### CROSS-REFERENCE TO RELATED APPLICATION

This patent application claims the benefit of U.S. Provisional Patent Application Number 61/992,344, entitled “TipQuik electronic commerce system used to give tips, write a review and track spending and earning systems,” filed May 13, 2014, which application is incorporated in its entirety here by this reference.

### TECHNICAL FIELD

This invention relates to systems and methods for electronic tipping, contribution, and feedback between individuals and/or businesses.

### BACKGROUND

Tipping is a tradition of providing money to show appreciation for services rendered. Tipping is expected in certain services, such as restaurants, valet parking, and food delivery, while it is considered optional in other services. Tipping is generally handed over directly to the recipient, dropped in a tip container, or handwritten on a credit card slip. Unfortunately, there are many uncertainties associated with tipping.

Ideally, a tipper would want to show a proper level of appreciation to a specific person for a specific service received. However, it is not always clear what constitutes a proper tip, as different regions and services have differing protocols for the amounts and distribution of tips. For example, a tip may be split amongst several individuals in an establishment, thus preventing the intended receiver from understanding the intended goodwill associated with the tip. As an added barrier, tippers do not always have the necessary cash or change on hand to provide a proper tip to the intended tippee, and tracking tips from cash and credit card transactions throughout a day of work can be inconvenient for the tippee.

There are peer-to-peer electronic transaction methods that ensure that an intended receiver receive an intended amount of money. However, these methods generally require that each party disclose personal information to the other person that a service provider may not feel comfortable disclosing to a stranger.

For the foregoing reasons there is a need for a system and method of transferring funds that is convenient, direct, and private.

### SUMMARY

The present invention is directed to an electronic tipping, contribution, and feedback system and method using a mobile application for convenience and privacy. The method comprises using a mobile device with an installed application to identify and transfer funds to a person or business with a limited exchange of personal information. A giver and receiver of a fund transfer each chooses his or her own level of identification information disclosure, allowing for anonymous fund transfers for givers and minimal disclosure for receivers.

It is an object of the present invention to provide a system and method for a giver of a fund transfer to identify a potential receiver of a fund transfer without requiring detailed disclosure of personal information from the receiver to the giver.

It is also an object of the present invention to provide a feedback interface for givers to provide feedback to a receiver to share information with a receiver for services provided.

It is also an object of the present invention to provide a system and method that is convenient to users for transferring funds and that provides incentives to users to join the system.

### BRIEF DESCRIPTION OF DRAWINGS

FIG. 1 is a diagram of an exemplary environment in which the present disclosure may be implemented;

FIG. 2A shows an exemplary flow diagram of a process in accordance with an embodiment of the present disclosure;

FIG. 2B shows a call diagram of processes in accordance with an embodiment of the present disclosure;

FIGS. 3A-3P show an exemplary computer implementation in accordance with an embodiment of the present disclosure; and

FIG. 4 shows a high-level diagram of a computing device that may be used to implement various aspects of the present disclosure in certain embodiments.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

It will be understood that, although the terms first, second, etc. may be used herein to describe various elements, these elements should not be limited by these terms. These terms are only used to distinguish one element from another. For example, a first gesture could be termed a second gesture, and, similarly, a second gesture could be termed a first gesture, without departing from the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that tipping and contributions are particular embodiments of fund transfers and are not intended to be limiting of the invention.

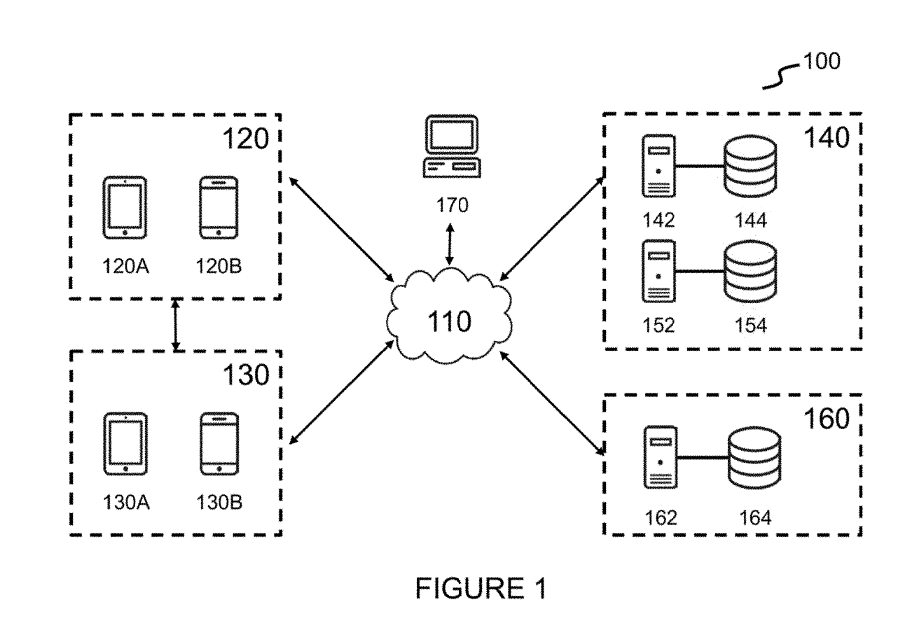

The collective environment for the electronic tipping, contribution, and feedback system and method can be provided and accessed in a variety of forms. FIG. 1 illustrates an exemplary environment 100 in which the present disclosure may be implemented. A plurality of mobile computing devices 120, 130 using proprietary applications may communicate with each other and system servers 142 and third party servers 152 in a computing environment 140 in order to facilitate the transfer of funds between multiple accounts, whether between the accounts on servers 162 and databases 164 in bank systems 160, and/or between accounts on the servers 142, 152 in the computing environment 140. In some embodiments, features of the system may be accessible from a desktop computer 170.

As illustrated in FIG. 1, a user at a mobile computing device 120A, 120B having a proprietary computer application accesses a computing environment 140 via a network 110. Within the computing environment 140, servers 142 can provide multiple services. For example, servers 142 can provide access to databases 144, websites, and interfaces with 3rd party service provider systems 152, 154 and bank systems 160. The servers 140 can include virtual computing and/or storage resources. A database 144 holding information regarding users, organizations, bank accounts, bank transfers, fund transfers, feedback, social media information, and/or saved contacts could be accessible from computing devices via a network 110, such as the Internet or cellular network. Examples of user information include the user's name, picture, email, password, user name, phone number, devices, profile, job title, job location, and employer connections. This data would preferentially be hidden behind security measures, and made public by request of the user.

In some embodiments, the computing environment 140 may be an application server for communication with mobile computing devices 120, 130. In some embodiments, the computing environment 140 may further comprise a website accessible via a browser on a computing device, such as a tablet 120A, 130A, smartphone 120B, 130B, or desktop computer 170. In some embodiments, the computing environment 140 may provide an accounting interface to track transfer of funds and provide a summary, such as for tax purposes or reimbursement records.

The computing environment 140 may further comprise third party servers 152 to facilitate communication with bank servers 162. For example, third party service providers may facilitate the authorization of bank transfers from a user bank account to a holding account for managing system funds or to a corporate account for handling fees. The third party service provider may also facilitate the authorization of bank transfers from the system holding account to a user bank account when a user withdraws funds from a user account.

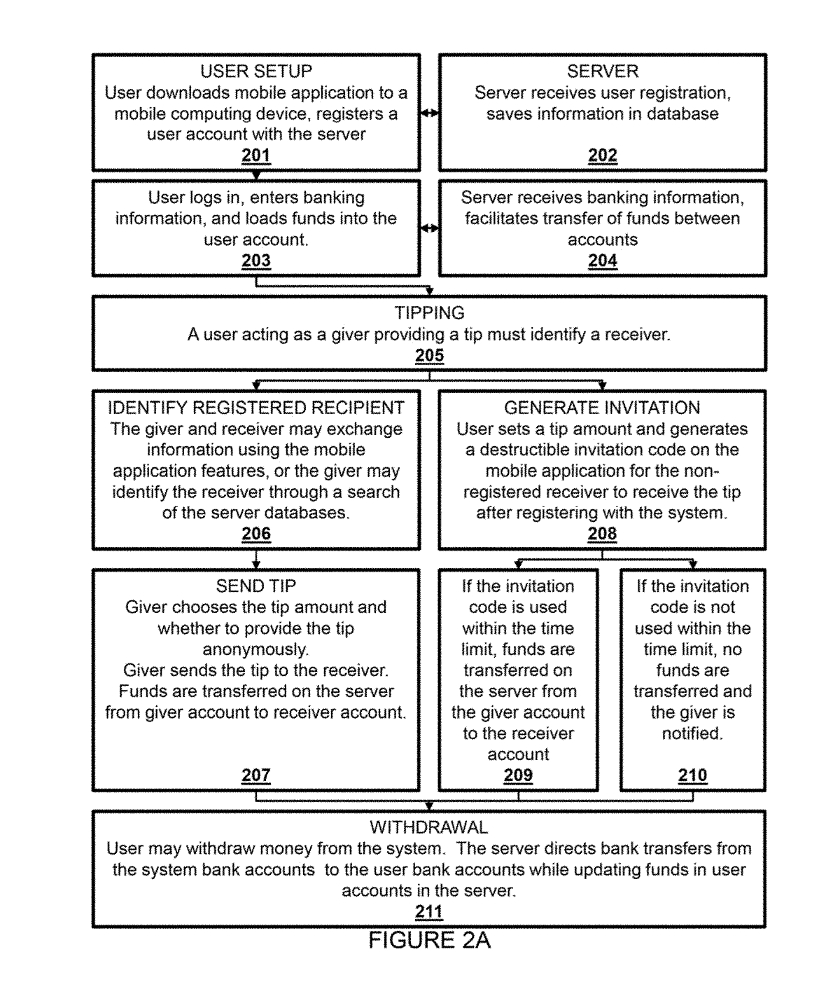

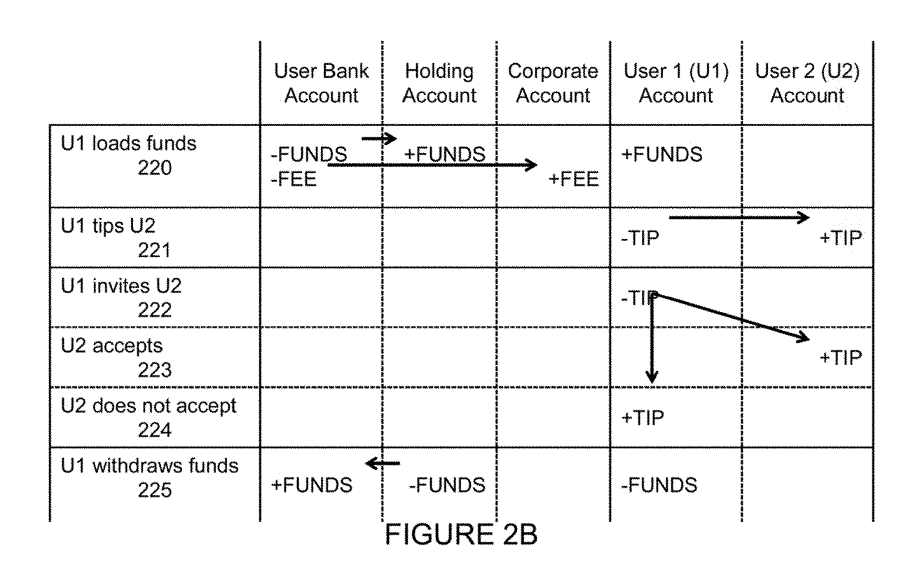

In various embodiments, the method steps described herein, including the method steps described in FIGS. 2A-2B, may be performed in an order different from the particular order described or shown. In other embodiments, other steps may be provided, or steps may be eliminated, from the described methods.

FIG. 2A shows an overall process of an embodiment of the system from the perspective of a user. Initially, in step 201, a user downloads a mobile application to a mobile computing device. For example, the mobile application may be made available on an application store, such as the Apple App Store or Google Play, or on a website. The user downloads the mobile application to the mobile computing device. The user registers a user account with the server through the application or a website. The server receives the user registration and saves the information in a database in step 202.

Once the user is registered, the user can login to the mobile application to begin using the application features in step 203. The user continues setting up once logged in. The user enters in banking information into the application, which is saved on the servers and verified for authenticity. In some embodiments, the application or server may communicate with third party servers to facilitate communication with bank servers in order to authenticate banking information and facilitate transfers. In some embodiments, a browser on a mobile computing device is used to communicate with servers over a network to communicate with the servers, third party service providers, or banking systems. Once banking information is authenticated, the user may transfer funds to the user account, in the process shown in FIG. 2B.

The user may set up a user profile to share identification information. In some embodiments, a minimum disclosure of identification information is required for receiving tips. For example, identification information can include a user's profile picture, name, occupation, job location, and employer, such that a giver can identify the user as the correct receiver for a tip.

In some embodiments, a user may have multiple user profiles to receive tips for multiple services/jobs. In some embodiments, each user profile may have unique codes to identify the user. In some embodiments, a menu with default options for occupation selection may be available for a user in setting up a profile. These occupations selections may be used in a recommendation engine in order to provide guidance to a giver attempting to tip a receiver.

In some embodiments, an organization may set up an organization account. A user may link a user account to an organization account in order to represent themselves as a member and/or employee of an organization account. In some embodiments, an organization account may distribute funds to user accounts linked to the organization account. In some embodiments, an organization account may manage feedback settings of the user accounts. In some embodiments, multiple user and/or organization accounts may be linked together, such as in a corporate structure, such as a store account, a regional account, and a corporate office account.

In some embodiments, a user may set up a location of work by address or GPS. By disclosing this information, users would enable themselves to be searchable on a map or by GPS. In some embodiments, a user may enter this information once to be permanently saved on the servers. In other embodiments, a user may clock in and clock out of a location to be searchable at that location during that time period.

Once a user has funds within the user account, the user may act as a giver and proceed to tip receivers in step 205. However, not every intended receiver may be registered with the electronic tipping system. Therefore methods of tipping both registered and non-registered receivers are provided.

In step 206, a user acting as a giver identifies a registered receiver. The mobile application provides multiple methods of identifying a registered receiver. As described below, these methods may utilize additional hardware of the mobile computing device and/or communicate with the server in identifying the registered receiver.

In some embodiments, the mobile application may identify users through machine readable optical labels, such as barcodes, QR codes, and the like. For example, a registered receiver may use the mobile application on the receiver's mobile computing device to generate and display a QR code on a display. The giver may use the mobile application on the giver's mobile computing device to access the camera and scan the QR code to identify the receiver. In some embodiments, the registered receiver may display the QR code in other places, such as on a receipt, business card, name tag, poster, or some other scannable surface.

In some embodiments, the mobile application may identify users through wireless transmission of information from one mobile computing device to another. For example, two mobile computing devices may communicate with each other through near field communication, Bluetooth, bump technology, or other such wireless communication methods. For security, users must authorize the mobile application to permit such communication. The registered receiver's mobile computing device would transfer designated identification information to the giver's mobile computing device.

In some embodiments, the mobile application may identify users through map location or GPS location. A receiver must authorize the being searchable in this way when setting up a user profile on the servers. A giver seeking to identify receivers would either perform a search of a map location, or would authorize the giver's mobile application to send the giver's GPS location to the servers and search for receivers in close proximity to the giver. Through this method, the giver may locate a list of potential receivers as a search result, and choose the correct receiver for tipping. These search results may be further filtered by other search criteria, such as the business, occupation, or other information registered in user profiles.

In some embodiments, the mobile application may communicate with the server to search the user database in order to find the receiver. For example, the giver may be able to search from username, email address, name, phone number, occupation, location, or any other criteria. Preferably, potential receivers would be required to consent to being searchable in such a database.

After a user identifies a registered receiver, the user may proceed to tip the registered receiver in step 207, or bookmark the registered receiver for later tipping. Bookmarking may be useful in protecting the identity of a giver intending to give an anonymous tip, as a receiver will not be able to deduce the identity of the giver from a timestamp of the tip. After setting the tip amount, the giver can proceed to send the tip. The transfer of funds is reflected in the user accounts of both users. In some embodiments, the giver and/or receiver will receive a confirmation message or a failure message after a transfer is initiated. If a failure message is received, a giver may be given the option of initiating the transfer again.

In some embodiments, a recommendation engine may be used to suggest a tip amount to the giver. The recommendation engine may base the recommendation on factors such as the identification information of the receiver or the average tip received by the receiver. For example, if a receiver registered as a barista, and the typical tip for a barista is $1.00, the recommendation may recommend a $1.00 to the giver. In another example, the receiver may have received $1000.00 across 500 unique transactions, therefore resulting in an average of $2.00. The recommendation engine may base a recommendation on such a calculation. In another example, the recommendation engine may calculate the statistics of all baristas in the server in a particular region to find an average tip for that particular occupation.

In some embodiments, the giver may be given additional options in sending a tip. For example, in some embodiments, the giver may be given the option to send the tip anonymously, wherein the receiver's mobile application will not show the giver's identification information.

In some embodiments, a giver may provide additional feedback to the receiver. The feedback may include, but is not limited to, sending messages, providing a rating/review, providing video review/testimonials, and the like. This gives the receiver instantaneous and direct information regarding performance without old fashioned methods of receiving such information, such as suggestion boxes, websites, surveys, receipts, or the like. This method allows a giver time to compose feedback that the giver knows the receiver will see, rather than a third party site review that the receiver may or may not notice.

In some embodiments, feedback tools are provided for a giver, wherein the giver determines if the feedback is provided to the receiver, to the receiver's business, and/or to the general public. In some embodiments, feedback tools are provided to a receiver, such that the receiver may choose which comments are public, which testimonials to use with the user profile, which givers to highlight as favorites, and the like.

In some embodiments, feedback tools are provided to an organization account linked to a user account. The organization account may manage how feedback is distributed, such as if the feedback is distributed to the user account and/or to the organization account. This assures a giver that the feedback is reviewed and provides an incentive to receivers to improve performance.

In some embodiments, an organization account may distribute feedback from one user account to another user account and/or organization account. For example, a makeup artist at a department store booth has a user account linked to the department store's organization account. The department store also employs a floor manager with an organization account linked to the department store's organization account. The corporate account may choose to have feedback from the makeup artist's user account directed to the floor manager's corporate account and the department store's organization account so that each corporate account may review the makeup artist's performance.

When a giver seeks to provide a tip to a receiver that is not registered, they may instead send an invitation to the receiver to join the system in step 208. In a preferred embodiment, the invitation may be a destructible invitation code that a receiver may redeem for the tip amount specified by the giver. When an invitation is generated by a giver, the tip amount is withdrawn from the giver's account, and a timer for the time limit begins to count down. In some embodiments, there is a default time limit counter. In some embodiments, the giver sets the time limit. If the receiver redeems the code within the time limit by registering an account and entering a code, then the tip amount is transferred from the giver's account to the receiver's account in step 209. If the receiver does not redeem the code within the time limit, then the tip amount is returned to the giver's funds in step 210. In some embodiments, the giver will receive a confirmation message or a failure message upon the invitation being redeemed or expired.

In some embodiments, an incentive program may provide additional benefits to the giver and/or receiver. The system may allow users to unlock achievements, win prizes, and gain credits. For example, a user may be credited with $1 for each invitation sent that was redeemed by another user. If the user is able to successfully invite five people, the giver may be given an achievement, such as a badge to keep track of progress or to be displayed in the user's user profile. In some embodiments, the user may receive a reward for accomplishing certain milestones, such as a redeemable coupon for a small coffee for tipping 10 baristas.

Finally, when a user wishes to withdraw funds from an account, a user using the application may direct the servers to transfer funds to a bank account in step 211, with transferred funds being deducted from the user account.

In some embodiments, users may be provided detailed accounting tools in tracking transactions and feedback. These tools may be used to sort transactions by date, time, location, user, comments, type of receivers, and the like. In some embodiments, these transaction logs may be sent or accessible from other devices, such as a desktop computer. These tools may include reporting tools such as an itemized list of transactions. For example, this would allow a business traveler to include these transactions in a list of expense reports. In another embodiment, these tips may be used by a receiver for filing taxes.

FIG. 2B shows a call diagram of fund transfers in accordance with an embodiment of the present invention. The call diagram shows the flow of funds between bank accounts (user bank account, holding account, and corporate account) and between user accounts (user 1 account, user 2 account). A user bank account is a user's personal bank account used to load funds into the system. The holding account is a bank account the system uses to hold funds until they are withdrawn from a user. The holding account may hold funds from multiple users. The corporate account is an account used to collect fees from users of the system. The user accounts are virtual accounts stored on the system servers and used to track the funds of each user. The funds change based on a user loading funds, withdrawing funds, and fund transfers between other users. Funds transferred between users do not directly affect funds stored in the holding account. This separation of bank accounts and user accounts on the server allows the system to facilitate anonymous tipping.

When user 1 loads funds into a user account in step 220, funds from user 1's authenticated bank account are transferred to the holding account. In this example embodiment, loading funds also requires the payment of a fee, which is transferred from the user bank account to a corporate account. In some embodiments, other methods of fee structures may be provided, such as by charging a monthly subscription or by charging withdrawal fees. The funds transferred to the holding account are credited to the user 1 account on the server. User 1 can monitor the amount of money in the user 1 account from the mobile application on the mobile computing device, and use those funds for tipping.

Peer-to-peer transactions do not require activity from a bank, as shown in step 221 through 224. When user 1 tips user 2 in step 221, the tip amount is deducted from user 1 and credited to user 2. When user 1 sends an invitation to user 2 in step 222, user 1's account is initially deducted the tip amount. If user 2 accepts the invitation, then user 2's account is credited the tip amount. However, if user 2 allows the invitation to expire in step 224, then the tip amount is returned to user 1's account.

When user 1 wishes to withdraw funds from his/her user 1 account, then the mobile application will direct the server to transfer funds from the holding account to the user's bank account in step 225, and deduct those funds from the user 1 account.

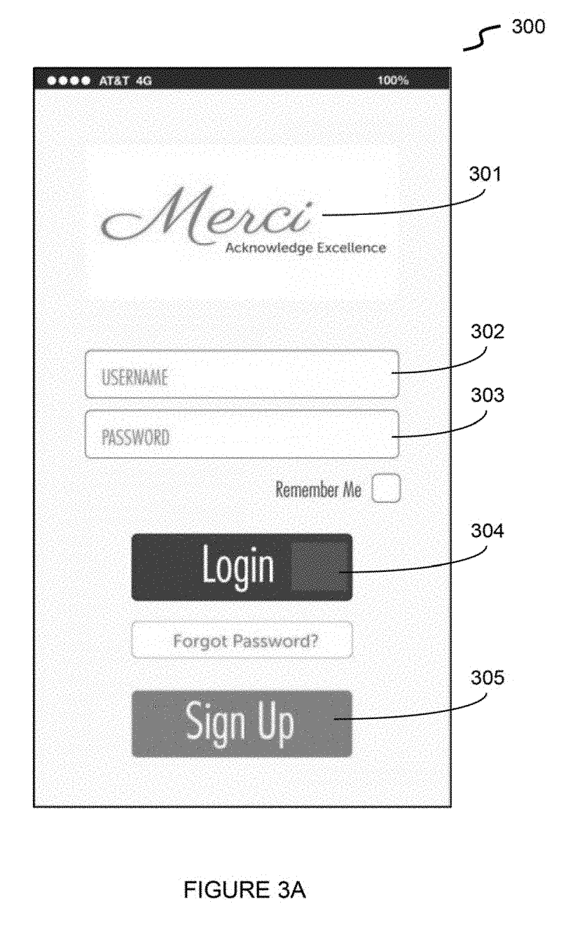

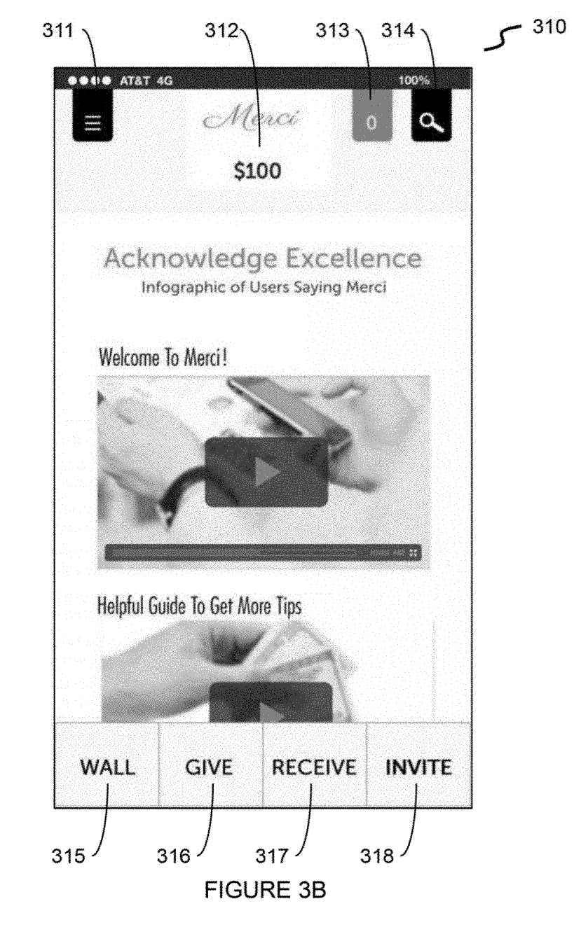

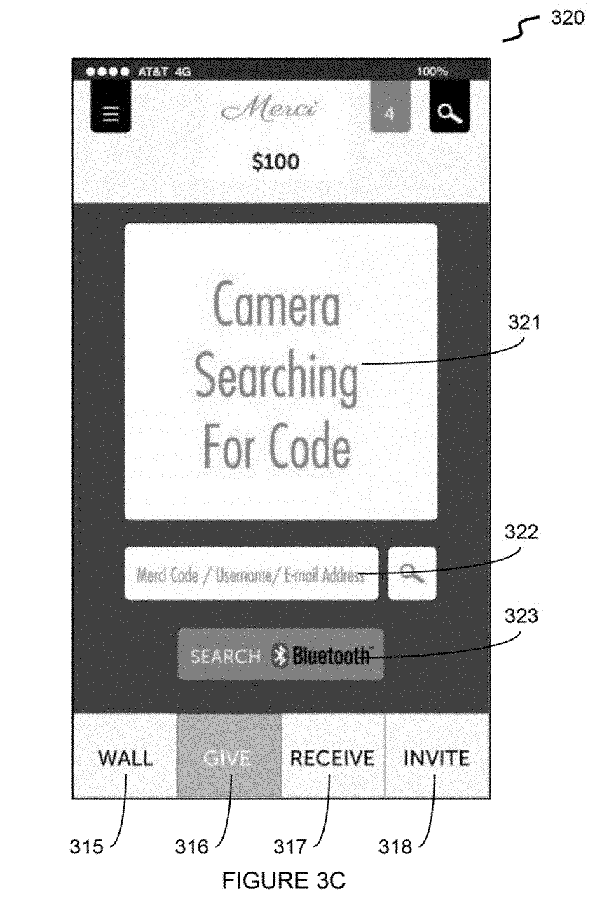

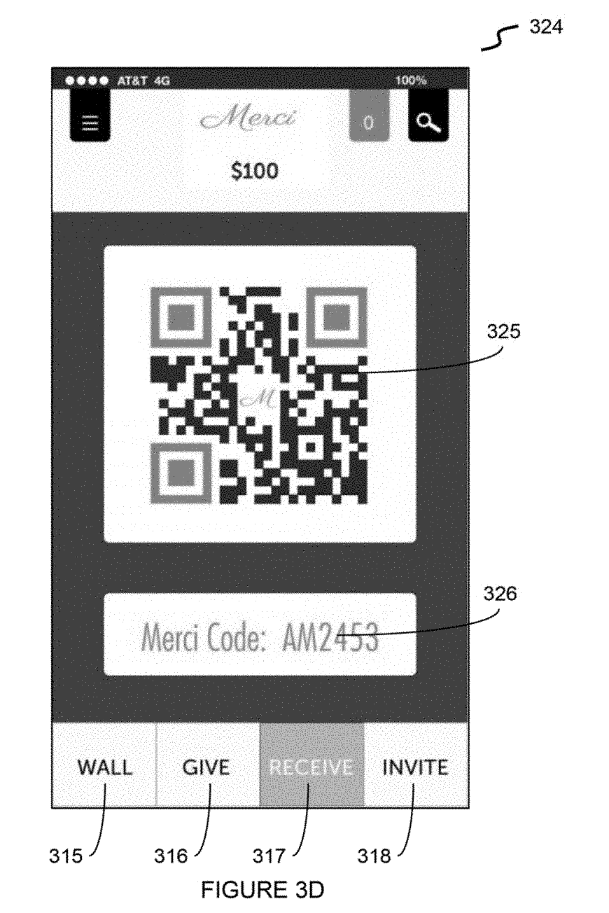

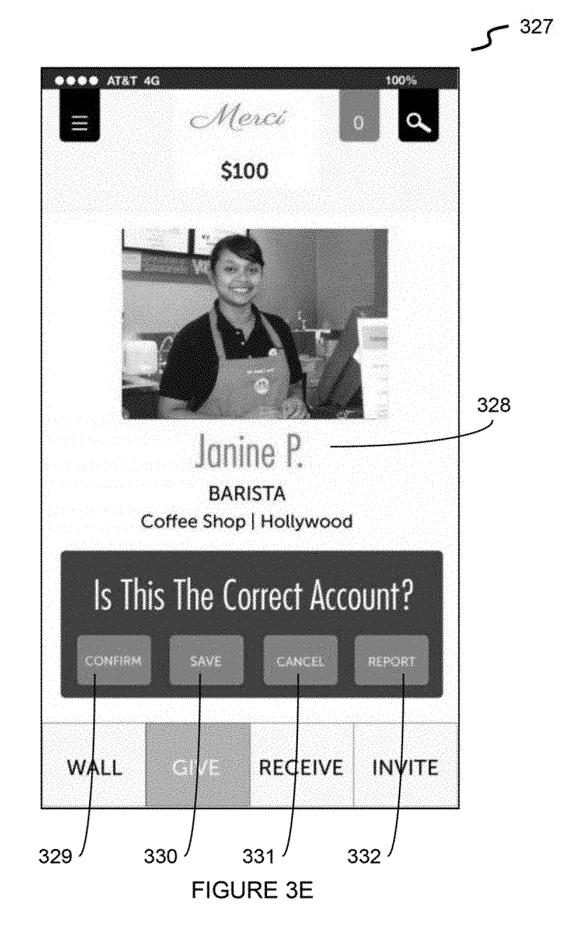

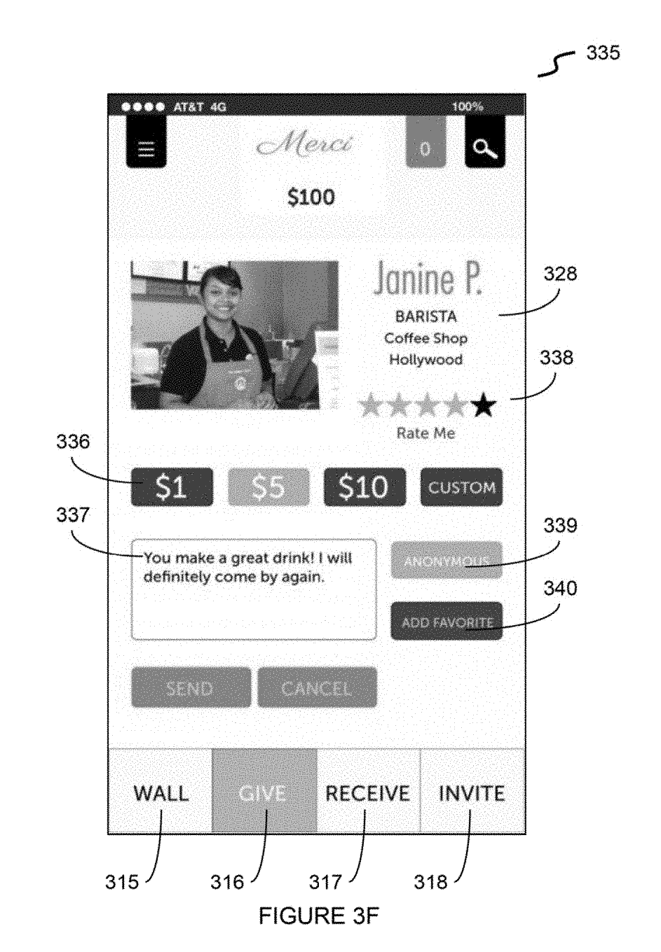

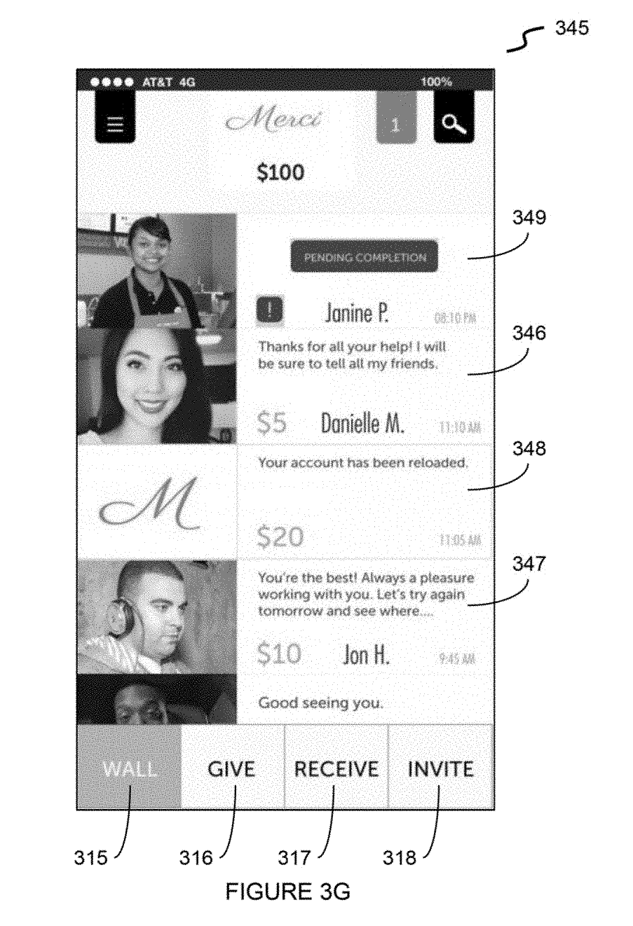

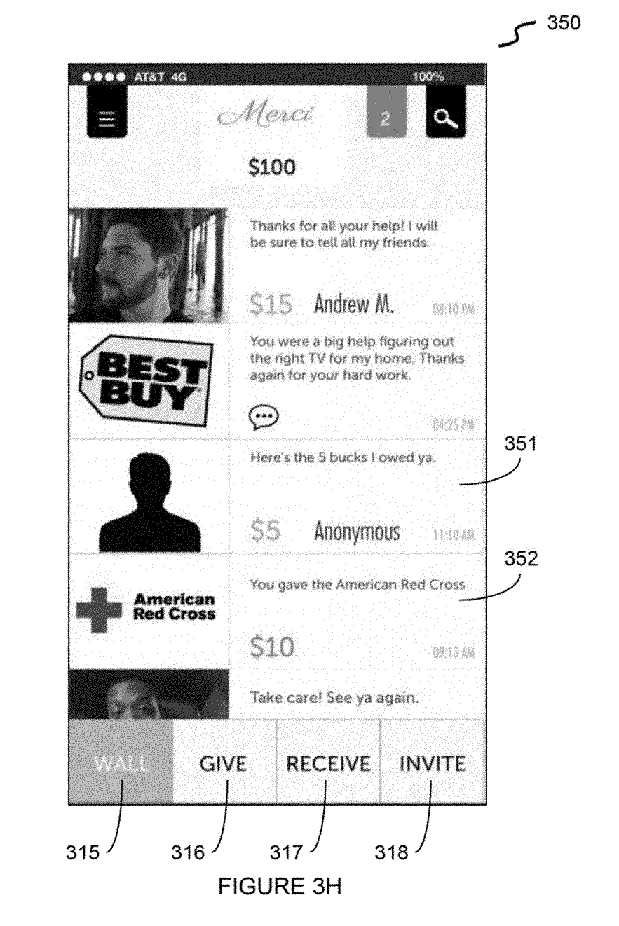

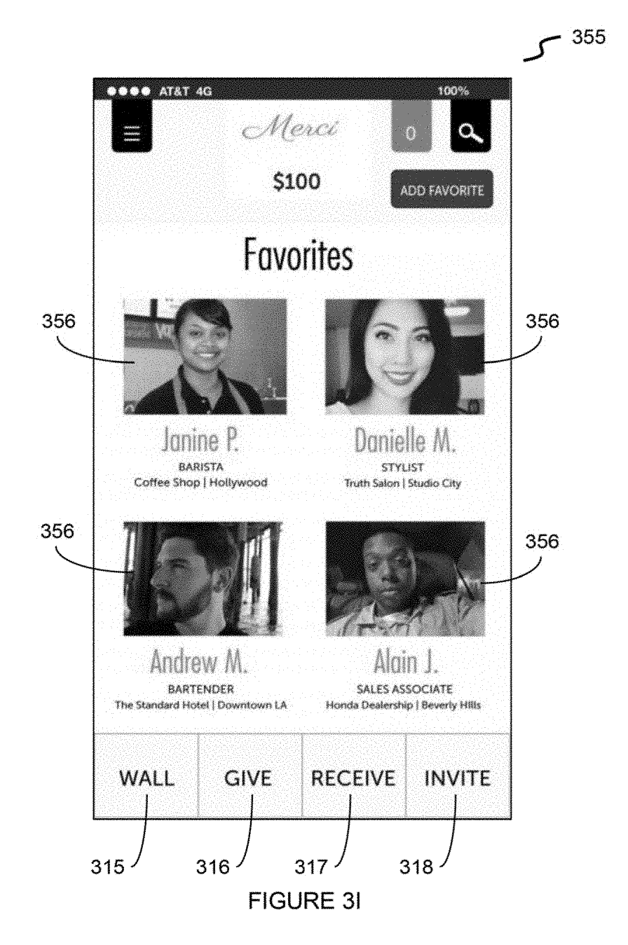

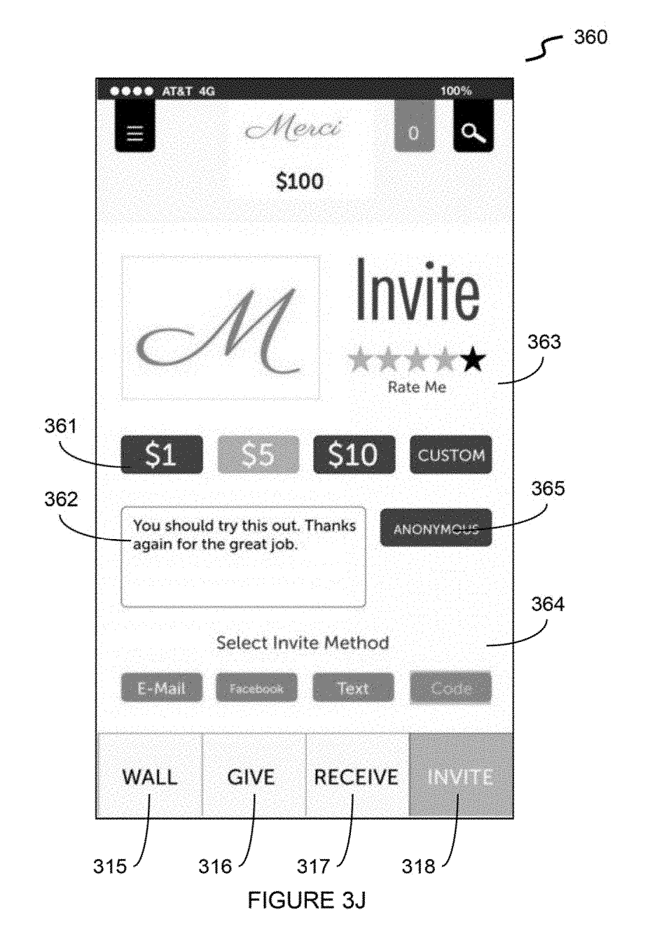

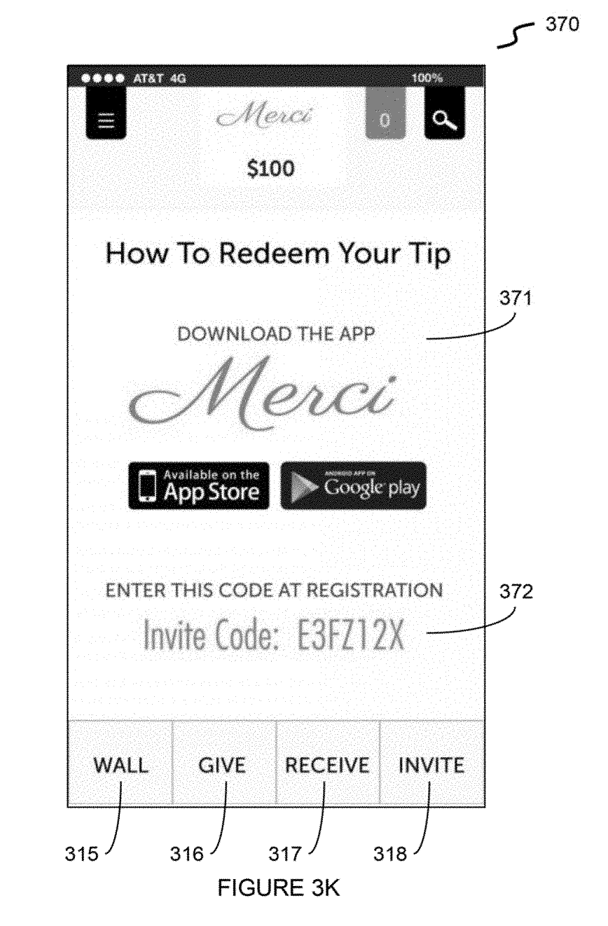

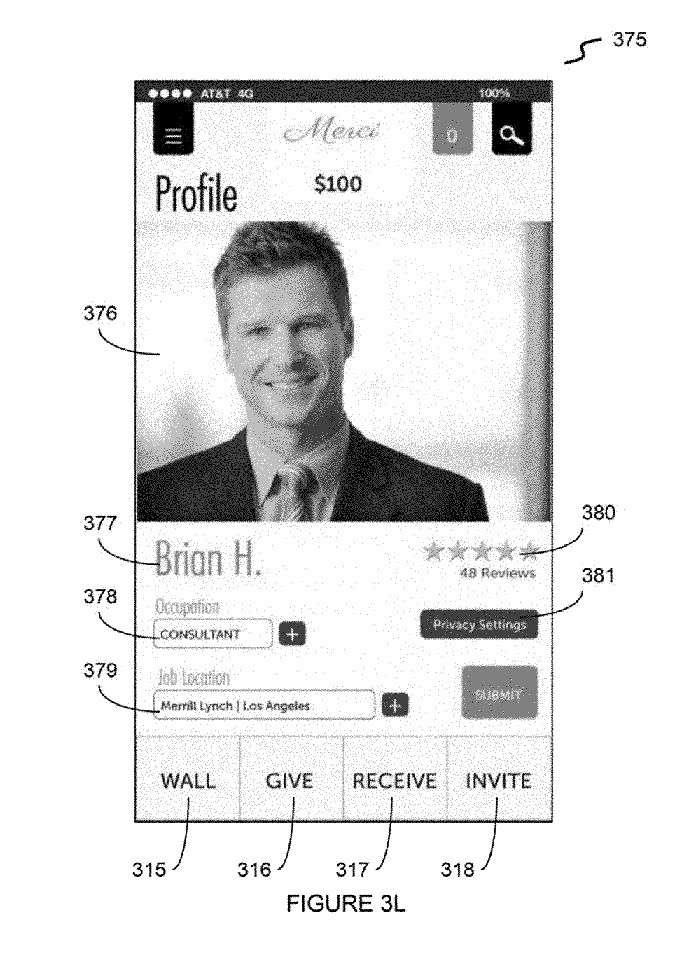

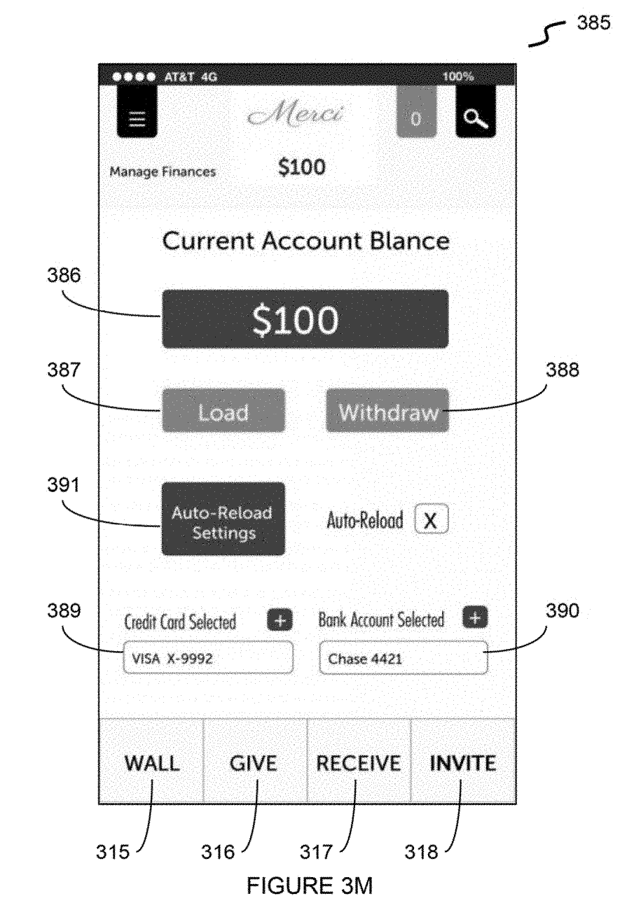

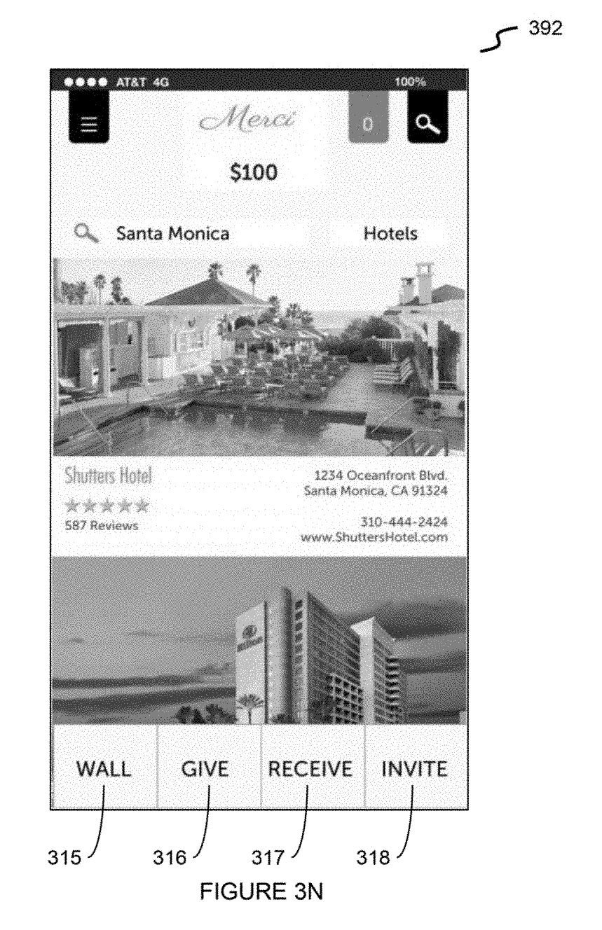

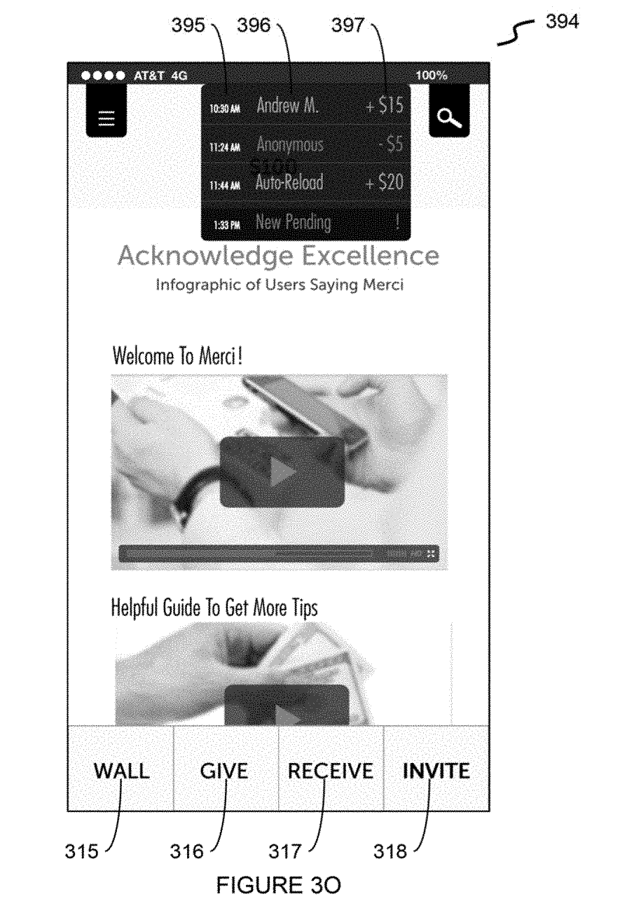

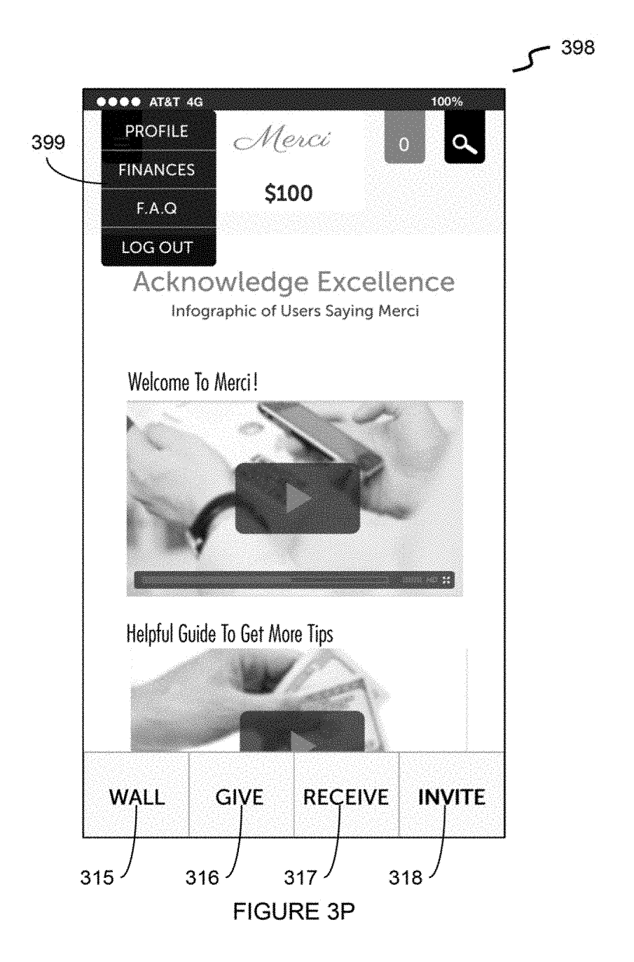

FIGS. 3A-3P show an exemplary implementation of a user interface for a mobile application in accordance with an embodiment of the present invention.

FIG. 3A shows an example login screen 300 that a user would encounter upon initially opening the mobile application. A logo 301 may be shown to identify the application to the user. New users would sign up for an account using the sign up button 305, while existing users would login by entering their username 302 and password 303 and clicking the login button 304.

FIG. 3B shows an example home screen 310. The example home screen displays the user interface showing a menu tab 311, an account balance 312, a notification tab 313, and a search button 314. The example home screen may also display buttons/tabs to reach the other screens, such as the wall tab 315, give tab 316, receive tab 317, and invite tab 318. In some embodiments, the home screen includes instructions to the users. In some embodiments, the home screen includes system statistics. For example, the home screen may show the number of transactions conducted in the system for the day, or the amount of money that has been transferred to a particular occupation.

FIG. 3C shows an example give screen 320. This allows a user to identify a registered receiver in order to give a tip. A giver may position the mobile computing device to capture a QR code with a camera in the camera window 321, search the system servers and databases through inputting text in a search field 322, or communicate with a wireless capable device such as through Bluetooth searching 323. In some embodiments, further features such as searching by GPS may be displayed.

FIG. 3D shows an example receive screen 324. In this receive screen 324, the mobile application generates codes that may be recognized by a mobile application on a giver's mobile computing device seeking to identify the receiver. The codes shown in this example include a QR code 325 to be scanned by a camera and a text code 326 to be inputted by a giver using a keyboard.

FIG. 3E shows an example confirmation screen 327. The confirmation screen 327 shows the identification information 328 of a receiver on the display of the giver's mobile computing device. This is to ensure that the identified user is the correct receiver for the tip. The giver may then choose from the buttons to confirm 329, save 330, cancel 331, or report 332. These may be used to confirmation the identified user as a receiver, save the identified user's information for later tipping, cancel the search for a receiver, and reporting suspicious activity about a user account. In the example embodiment, the identification information 328 includes the receiver's profile picture, first name and last initial, occupation, and store/location. In some embodiments, the identification information is required at a minimum to show the initials and a geographic location of the receiver.

FIG. 3F shows an example transaction screen 335. In this transaction screen 335, givers may set a tip amount 336, and may additionally send text 337, rate the receiver 338, choose to tip anonymously 339, and save the contact as a favorite 340.

FIG. 3G shows an example wall screen 345. The wall screen 345 shows a list of transactions in the user's account history. These transactions may include, but are not limited to, tips given to other users 346, tips received from other users 347, account updates 348, and saved receivers for future tips 349.

FIG. 3H shows another example wall screen 350. This screen shows an example of a received anonymous tip 351 and a contribution to a charity organization 352. As shown for the anonymous tip 351, the receiver does not receive identification information of the giver. In this instance, the receiver sees the tip amount, the timestamp, and a message from the giver. As shown in the contribution to the charity organization 352, in some embodiments, organizations may register accounts with the system.

FIG. 3I shows an example favorites screen 355. The favorites screen 355 shows the identification information of users 356 the giver has previously saved as a favorite. A giver may save favorites in order to skip the identification of the receiver each time the giver wishes to tip the receiver. In some embodiments, further information may be saved regarding the favorites. For example, a user may save a standard tip for each favorite to be re-used each time the favorite is tipped.

FIG. 3J shows an example invitation screen 360. In this example, a user providing an invitation sets a tip amount 361, a text message 362, a rating 363, and an invitation method 364. As shown, this tip may be provided anonymously by clicking the anonymous button 365. The invitation methods 364 shown in this example include invitations by e-mail, Facebook, text, and code. Once sent, a code is generated and included in the invitation for the receiver to redeem. In some embodiments, the code is embedded in a link that is sent to a receiver, and a receiver is required to click the link to redeem the code.

FIG. 3K shows an example invite code screen 370. This screen appears if a giver selects the code invitation method. The invite code screen 370 gives instructions 371 on how to join the system and displays the generated code 372 on the display of the mobile computing device. This allows a receiver to copy down the code or take a picture of the code for later redemption.

FIG. 3L shows an example of a user profile 375. The user profile 375 shows identification information, such as the user's picture 376, name 377, occupation 378, and job location 379. The user profile also has privacy settings 381 to limit what other users may receive or search for. In this example, the profile also displays a rating and reviews 380. In some embodiments, a user may have more than one user profile for receiving tips, as a user may have multiple occupations. The user would preferably tailor the profile to fit each occupation. Having multiple user profiles may additionally benefit a user in keeping track of fund transfers for accounting purposes.

FIG. 3M shows an example of a finance screen 385. The account balance 386 is shown. Users may input banking information, such as a credit card 389 or bank account 390, which is verified through the system server, third party service providers, or directly with banks The user may load 387 and/or withdraw 388 funds and set auto-reload settings 391 to load funds whenever the account balance falls below a threshold.

FIG. 3N shows an example business search result screen 392. As shown, a user may search the system databases in order to find a business by location, type of service, name, or other such criteria. Search results provide reviews, ratings, and basic information about the business. In some embodiments, a business's employees may also be displayed so a user may select and tip specific employees of the business.

FIG. 3O shows an example a notification window 394. As shown, recent transaction may be shown with information such as the timestamp 395, the party 396, and the tip amount 397. Additionally, alerts reminding a user to complete a tip may be displayed. In some embodiments, a numbered notification icon shows when the notification window is collapsed to inform the user of new transactions and/or feedback, wherein the notification icon disappears once the latest information has been viewed.

FIG. 3P shows an example of a screen 398 with a menu 399 open, allowing a user to reach the user profile screen, review finances and transaction, read frequently asked questions, or log out of the system.

Systems, apparatus, and methods described herein may be implemented using digital circuitry, or using one or more computing devices using well known computer processors, memory units, storage devices, computer software, and other components. Typically, a computing device includes a processor for executing instructions and one or more memories for storing instructions and data. A computing device may also include, or be coupled to, one or more storage devices, such as one or more magnetic disks, internal hard disks and removable disks, optical disks, etc.

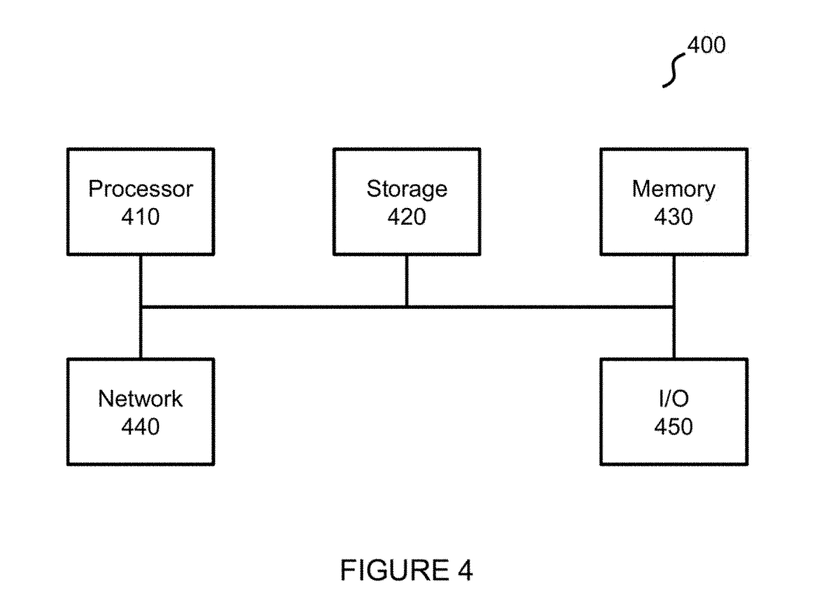

A high-level block diagram of an exemplary computing device 400 that may be used to implement systems, apparatus, and methods described herein is illustrated in FIG. 4. The computing device 400 comprises a processor 410 operatively coupled to a data storage device and memory. Processor 410 controls the overall operation of the computing device 400 by executing computer program instructions that define such operations. The computer program instructions may be stored in data storage device 420, or other non-transitory computer readable medium, and loaded into memory 430 when execution of the computer program instructions is desired. Thus, the method steps of FIGS. 2A-2B can be defined by the computer program instructions stored in memory 430 and/or data storage device 420 and controlled by processor 410 executing the computer program instructions.

For example, the computer program instructions can be implemented as computer executable code programmed by one skilled in the art to perform an algorithm defined by the method steps in FIGS. 2A-2B. Computing device 400 also includes one or more network interfaces 440 for communicating with other devices via a network. Computing device 400 also includes one or more input/output devices 450 that enable user interaction with computing device 400 (e.g., display, keyboard, touchpad, buttons, etc.).

Processor 410 can include, among others, special purpose processors with software instructions incorporated in the processor design and general purpose processors with instructions in storage device 420 or memory 430, to control the processor 410, and may be the sole processor or one of multiple processors of computing device 400. Processor 410 may be a self-contained computing system, containing multiple cores or processors, a bus, memory controller, cache, etc. A multi-core processor may be symmetric or asymmetric. Processor 410, data storage device 420, and/or memory 430 may include, be supplemented by, or incorporated in, one or more application-specific integrated circuits (ASICs) and/or one or more field programmable gate arrays (FPGAs). It can be appreciated that the disclosure may operate on a computing device 400 with one or more processors 410 or on a group or cluster of computing devices networked together to provide greater processing capability.

Data storage device 420 and memory 430 each comprise a tangible non-transitory computer readable storage medium. By way of example, and not limitation, such non-transitory computer-readable storage medium can include random access memory (RAM), high-speed random access memory (DRAM), static random access memory (SRAM), double data rate synchronous dynamic random access memory (DDRRAM), read-only memory (ROM), erasable programmable read-only memory (EPROM), electrically erasable programmable read-only memory (EEPROM), flash memory, compact disc read-only memory (CD-ROM), digital versatile disc read-only memory (DVD-ROM) disks, or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computing device, the computing device properly views the connection as a computer-readable medium. Thus, any such connection is properly termed a computer-readable medium. Combinations of the above should also be included within the scope of the computer-readable media.

Network/communication interface 440 enables the computing device 400 to communicate with networks, such as the Internet, also referred to as the World Wide Web (WWW), an intranet and/or a wireless network, such as a cellular telephone network, a wireless local area network (LAN) and/or a metropolitan area network (MAN), and other devices using any suitable communications standards, protocols, and technologies. By way of example, and not limitation, such suitable communications standards, protocols, and technologies can include Ethernet, Wi-Fi (e.g., IEEE 802.11), Wi-MAX (e.g., 802.16), Bluetooth, near field communications (“NFC”), radio frequency systems, infrared, GSM, EDGE, HS-DPA, CDMA, TDMA, quadband, VoIP, IMAP, POP, XMPP, SIMPLE, IMPS, SMS, or any other suitable communications protocols. By way of example, and not limitation, the network interface 440 enables the computing device 400 to transfer data, synchronize information, update software, or any other suitable operation.

Input/output devices 450 may also include parts of a computing device, such as a smartphone having a camera, a touchscreen, a display, buttons, speakers, and the like. For example, input/output devices 450 may include a display device such as a liquid crystal display (LCD) monitor for displaying information to the user, touchscreen by which the user can provide input and output to the computing device 400, or a camera for capturing QR codes. Input/output devices 450 may include peripherals.

Any or all of the systems and apparatus discussed herein, including personal computers, tablet computers, hand-held devices, cellular telephones, servers, database, cloud-computing environments, and components thereof, may be implemented using a computing device such as computing device 400.

One skilled in the art will recognize that an implementation of an actual computing device or computer system may have other structures and may contain other components as well, and that FIG. 4 is a high level representation of some of the components of such a computing device for illustrative purposes.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

1. A system for transferring funds in the form of a tip to a receiver from a giver with limited knowledge of the receiver, the system comprising:
a. a server;
b. a database;
c. a mobile computing device comprising a display, a camera, one or more processors, memory, and one or more programs, wherein the one or more programs are stored in the memory and configured to be executed by the one or more processors, the one or more programs including instructions to:
i. register a first user account of a first user with the server and store the first user account in the database;
ii. load a tip to the first user account, wherein loading the tip comprises directing the server to transfer the tip from a user bank account into a system bank account, and crediting the tip to the first user account in the database;
iii. withdraw the tip from the first user account, wherein withdrawing the tip comprises directing the server to transfer the tip from the system bank account to the user bank account, and deducting the tip from the first user account in the database;
iv. generate a first identification code and display the first identification code on the display, whereby the first identification code identifies the first user account to other user accounts;
v. identify a second user account using the camera, wherein identifying the second user account using the camera comprises scanning a second identification code generated by the second user account, and displaying identification information of the second user account on the display;
vi. direct the server to transfer the tip from the first user account to the second user account;
vii. generate an invitation for creating a third user account, wherein generating an invitation comprises generating an invitation code redeemable using the one or more programs, directing the server to transfer a tip from the first user account to the third user account if the invitation code is redeemed by creation of the third user account within a limited time period, invalidating the invitation code if the invitation code is not redeemed by the creation of the third user account within the limited time period;
viii. configure the identification information of the first user account to limit disclosure of identification information, wherein the identification information has a minimum disclosure setting, whereby a fourth user account viewing identification information of the first user account can confirm the first user account correctly identifies a user of the mobile computing device; and
d. whereby the one or more programs are used by a giver to identify and transfer money to a receiver, with the giver knowing limited identification information of the receiver.

2. The system of claim 1, wherein directing the server to transfer funds further comprises hiding identification information of the first user account, whereby the second user account receives an anonymous fund transfer from the first user account.

3. The system of claim 2, wherein the one or more programs further comprise instructions to store the identification information of the second user account, whereby the identification information of the second user account may be used for reminders for future transfers, time-displacement for anonymous fund transfers, and multiple fund transfers without identifying the second user account again.

4. The system of claim 3, wherein directing the server to transfer funds further comprises sending feedback from the first user account to the second user account.

5. The system of claim 4, wherein the first identification code and second identification code are Quick Response codes.

6. The system of claim 5, wherein the one or more programs further include instructions to identify the second user account through wireless communication, wherein identifying the second user account through wireless communication comprises wirelessly communicating with the second user account on a second mobile computing device, and displaying identification information of the second user account on the display.

7. The system of claim 6, wherein the one or more programs further include instructions to identify the second user account through GPS location, wherein identifying the second user account through GPS location comprises determining a GPS location of the mobile computing device, directing the server to search the database based on the GPS location, and displaying identification information of user accounts near the GPS location on the display.

8. The system of claim 7, wherein the one or more programs further include instructions to identify the second user account through a database search, wherein identifying the second user account through the database search comprises sending a search criteria to the server, directing the server to search the database for user accounts matching the search criteria, and displaying identification information of user accounts matching the search criteria on the display, whereby the second user account may be identified by username, business name, and type of business.

9. The system of claim 8, wherein the one or more programs further includes instructions to register an organization account, wherein the organization account is operable to be linked to user accounts, wherein a fund transfer to the organization account is distributed to linked user accounts, whereby fund transfers to an organization may be shared among its linked accounts.

10. The system of claim 9, wherein the second user account is linked to an organization account, and wherein directing the server to transfer funds further comprises sending feedback from the first user account to the organization account linked to the second user account.

11. A method for electronically transferring funds in the form of a tip from a giver to a receiver, the method comprising:
at a mobile computing device having a display and a camera:
a. registering a first user account with a server and storing the first user account in a database;
b. loading funds to the first user account, wherein loading funds comprises directing the server to transfer funds from a user bank account into a system bank account, and crediting the funds to the first user account in the database;
c. withdrawing funds from the first user account, wherein withdrawing funds comprises directing the server to transfer funds from the system bank account to the user bank account, and deducting the funds from the first user account in the database;
d. generating a first identification code and displaying the first identification code on the display, whereby the first identification code identifies the first user account to other user accounts;
e. identify a second user account using the camera, wherein identifying the second user account using the camera comprises scanning a second identification code generated by a second user account, and displaying identification information of the second user account on the display;
f. directing the server to transfer funds from the first user account to the second user account;
g. generating an invitation for creating a third user account, wherein generating the invitation comprises generating an invitation code redeemable using the one or more programs, directing the server to transfer funds from the first user account to the third user account if the invitation code is redeemed by creation of the third user account within a limited time period, invalidating the invitation code if the invitation code is not redeemed by the creation of the third user account within the limited time period;
h. configuring the identification information of the first user account to limit disclosure of identification information, wherein the identification information has a minimum disclosure setting, whereby a fourth user account viewing identification information of the first user account can confirm the first user account correctly identifies a user of the mobile computing device; and
i. whereby the giver with limited knowledge of the receiver can identify and transfer funds to the receiver.

12. The method of claim 11, wherein directing the server to transfer funds further comprises hiding identification information of the first user account, whereby the second user account receives an anonymous fund transfer from the first user account.

13. The method of claim 12, further comprising storing the identification information of the second user account in a memory of the mobile computing device, whereby the identification information of the second user account may be used for reminders for future fund transfers, time-displacement for anonymous fund transfers, and multiple fund transfers without identifying the second user account again.

14. The method of claim 13, wherein directing the server to transfer funds further comprises sending feedback from the first user account to the second user account.

15. The method of claim 14, wherein the first identification code and second identification code are Quick Response codes.

16. The method of claim 15, further comprising identifying the second user account through wireless communication, wherein identifying the second user account through wireless communication comprises wirelessly communicating with the second user account on a second mobile computing device, and displaying identification information of the second user account on the display.

17. The system of claim 16, further comprising identifying the second user account through GPS location, wherein identifying the second user account through GPS location comprises determining a GPS location of the mobile computing device, directing the server to search the database based on the GPS location, and displaying identification information of user accounts near the GPS location on the display.

18. The method of claim 17, further comprising identifying the second user account through a database search, wherein identifying the second user account through the database search comprises sending a search criteria to the server, directing the server to search the database for user accounts matching the search criteria, and displaying identification information of user accounts matching the search criteria on the display, whereby the second user account may be identified by username, business name, and type of business.

19. The method of claim 18, further comprising registering an organization account, wherein the organization account is operable to be linked to user accounts, wherein a fund transfer to the organization account is distributed to linked user accounts, whereby fund transfers to an organization may be shared among its linked accounts.

20. The system of claim 19, wherein the second user account is linked to an organization account, and wherein directing the server to transfer funds further comprises sending feedback from the first user account to the organization account linked to the second user account.
